(19) United States
(12) Patent Application Publication
(10) Pub. No.: US 2011/0196949 A1
(43) Pub. Date: Aug. 11, 2011

(54) SYSTEM FOR REMOTE ACCESS AND MAINTENANCE TO A WIDE AREA NETWORK

(76) Inventors: Naquib U. Hatami, Bristow, VA (US); Duncan Masale, Laurel, MD (US)

(21) Appl. No.: 12/703,391

(22) Filed: Feb. 10, 2010

(51) Int. Cl. G06F 15/163

(52) U.S. Cl. 709/223

(57) ABSTRACT

Addition of a wireless out-of-band communications channel to a WAN enabling expeditious communication to a WAN data processor from a NOC. A wireless network device which may be one of a router or a switch comprises a communications port which may be for example a network device console port or a universal serial bus (USB) port may be communicably connected to a wireless console communications device (WIFIC). Management programming entered into a data processor at the NOC may be functional to direct communications directly to the wireless network device using a wireless communications link which avoids the usual in-band communications channel.

### FIELD OF THE INVENTION

The present invention relates to connections facilitating remote maintenance and operation of a data processor of a wide area network (WAN) from a central location by providing wireless communications to a console port of the data processor.

### BACKGROUND OF THE INVENTION

A WAN typically comprises geographically separated data processors and other components which occasionally require maintenance, corrective actions, and the like in order to operate properly. Large scale operators of WANs such as corporations and institutions may maintain a network operation center (NOC) where trained maintenance personnel are present and available at all hours to assure operability of the system. All sorts of real and perceived problems may arise which demand the attention of the maintenance personnel, such as local power failures, failures of site circuits, nodes entrapped in an RMON mode, IP routing problems, and over-utilization of a circuit. These problems may prevent ordinary remote measures from being undertaken from the NOC, such as by using an SNMP protocol. Such problems have traditionally been addressed by dispatching personnel to the site of the problem or perceived site of the problem. Such troubleshooting may well solve the problem, but ties up skilled personnel for the duration of the troubleshooting. Conventional out-of-band solutions may for example utilize PSTN dialed connections or backup WAN technologies such as ISDN and SVC, which are slow, expensive, or otherwise objectionable. There exists a need for an improved remote connection which could result in remotely implemented solutions to many problems.

### SUMMARY OF THE INVENTION

The present invention provides an out-of-band wireless connection to components of a WAN which are remote from a central NOC to facilitate remote troubleshooting, thereby overcoming necessity of dispatching personnel to the site of the problem. A WIFI enabled console device is provided, which can be accessed by conventional wireless and wireless local area network (WLAN) technologies. A wireless console device (WIFIC) and a wireless console manager are provided to establish a fast acting communications link which overcomes the drawbacks of prior approaches.

The wireless console manager and the console device may securely communicate using a WLAN. Personnel such as a network engineer may address the wireless network manager via a LAN connected data processor or alternatively by using a wireless communications device such as a personal digital assistant (PDA), Smartphone®, laptop or Tablet® personal computer to console into a network device using a conventional program such as HyperTerminal®.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a diagrammatic depiction of a WAN equipped to operate according to the present invention.

FIG. 2 is a diagrammatic detail view of associated components of the WAN of FIG. 1.

### DETAILED DESCRIPTION

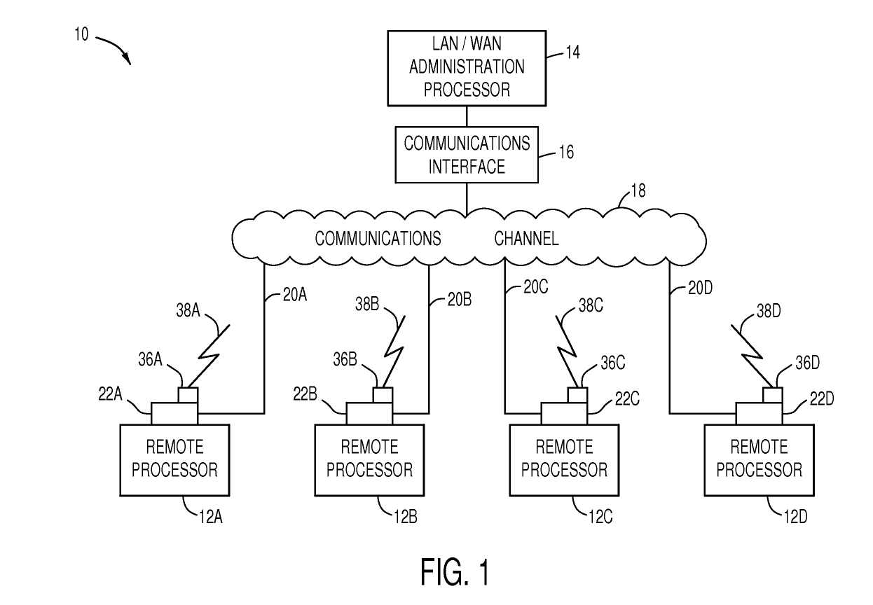

Referring first to FIG. 1, according to at least one aspect of the invention, there is shown a Wide Area Network (WAN) 10 providing expedited out-of-band wireless communications to geographically remote data processors 12A, 12B, 12C, 12D of the WAN 10 from an network operations center (NOC) data processor or WAN administration processor 14. The WAN administration processor 14 may comprise a communications interface device 16 which is adapted to communicate remotely via a communications channel such as the internet 18. The WAN administration processor 14 may comprise management programming entered thereinto, which management programming is functional to direct communications directly to a wireless console communications device (to be described hereinafter) which is connected to the communications port of each remote data processor 12A, 12B, 12C, 12D and out of the in-band communications channel.

It should be mentioned here that the WAN administration processor 14 may be accessed via a LAN computer or wirelessly via a Personal Digital Assistant (PDA) or the like, Smartphone, laptop computer, Tablet, and devices using HyperTerminal.

The internet 18 may connect to each remote data processor 12A, 12B, 12C, 12D via a conventional in-band communications channel such as respective direct or hard wired channels 20A, 20B, 20C, 20D. Each remote data processor 12A, 12B, 12C, 12D which participates in the novel out-of-band communications system is provided with a WIFI enabled console device 22A, 22B, 22C, 22D.

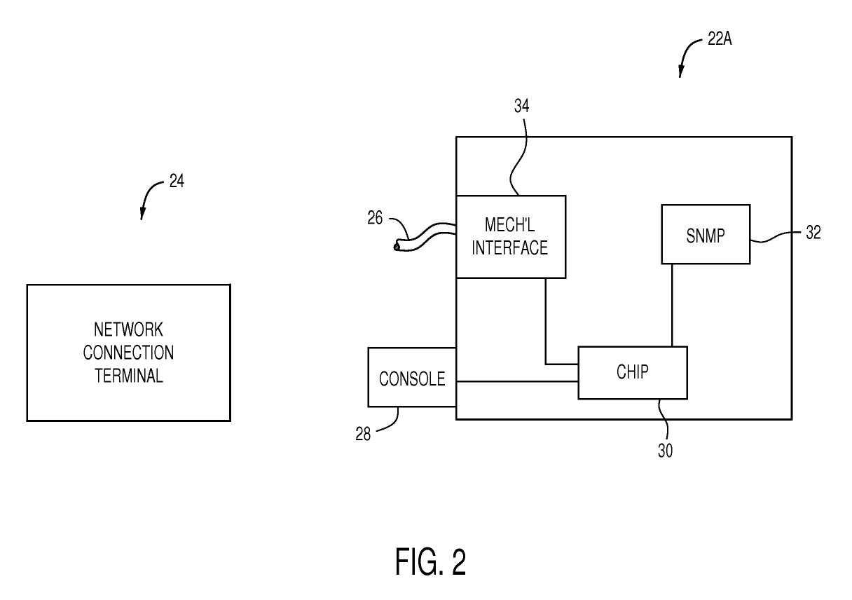

As seen in FIG. 2, each WIFI enabled console device or network device, the WIFI enabled console device 22A being shown in a representative capacity, may comprise a wireless switch or router and may also accommodate a conventional direct connection device such as a direct connection device 24, which enables a conventional mechanical connection using a data cable 26 or may alternatively using accommodating a direct plug in or insertable connection via a console port 28, for example.

The WIFI enabled console device such as the WIFI enabled console device 22A may comprise an integral microcircuit or chip 30, SNMP programming 32, and a mechanical connector such as the console port 28 which may operate as a plug-in device or a cable compatible mechanical interface 34 which may be a USB port or an RJ series terminal, such as an RJ-11 dial-up terminal or an RJ-45 LAN port, for example. The WIFI enabled console device 22A may be not only SNMP enabled, but RADIUS or TACACS protocol enabled, or may be web access enabled, or may display any of these in any combination.

The cable based or plug in based connections may be referred to as components of an in-band communications channel for routine use.

Again referring to FIG. 1, a WIFI enabled console device such as the WIFI enabled console devices 22A, 22B, 22C, 22D may each comprise a respective wireless console communications device (WIFIC) 36A, 36B, 36C, 36D disposed to connect to and communicate with the communications port of the network device. Wireless communications are shown representatively as 38A, 38B, 38C, 38D, and may proceed using any conventional wireless communications channel (WIFI), and may utilize the internet 18 for example. The WIFICs 36A, 36B, 36C, 36D may be disposed to support standard 802.11 data encryption and are SNMP capable.

The management programming of the WAN administration processor 14 may support WLAN, TCP/IP, SNMP, or any combination of these. The management programming of the WAN administration processor 14 may be accessible via a LAN IP address, via an HTTP web browser protocol, via a dial-in modem, or may be equipped to be accessible via any combination of these. The WAN 10 may comprise a secure access, authentication, and authorization protocol wherein the management programming is configured using at least one of TACACS, RADIUS, or LDAP.

It will be appreciated that while a WAN provides an advantageous system for utilizing the invention, it is equally possible to use the invention with other types of systems such as LANs and others. Far flung geographic distribution of processors such as the remote processors 12A, 12B, 12C, 12D is advantageously accommodated by the novel arrangement, but is not a necessity in practicing the invention. Also, although four remote data processors 12A, 12B, 12C, 12D are shown, any number of remote data processors including only one may be provided.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

We claim:

1. A Wide Area Network (WAN) providing expedited out-of-band wireless communications to at least one data processor of the WAN, comprising:
a network operations center (NOC) comprising at least one NOC data processor and an in-band communications channel;
at least one remote data processor which is geographically remote from the NOC;
a network device which is one of a router or a switch, and which comprises a communications port which is either one of a network device console port or a universal serial bus (USB) port;
a wireless console communications device (WIFIC) disposed to connect to and communicate with the communications port of the network device; and
management programming entered into a data processor at the NOC, which management programming is functional to direct communications directly to the wireless console communications device which is connected to the communications port of the remote data processor and out of the in-band communications channel.

2. The WAN of claim 1, wherein the WIFIC is disposed to support standard 802.11 data encryption and is SNMP capable.

3. The WAN of claim 1, wherein the network device is a router.

4. The WAN of claim 1, wherein the network device is a switch.

5. The WAN of claim 1, wherein the network device comprises a console port, and the WIFIC is insertable into the console port of the network device.

6. The WAN of claim 1, wherein the management programming supports WLAN.

7. The WAN of claim 1, wherein the management programming supports TCP/IP.

8. The WAN of claim 1, wherein the management programming supports SNMP.

9. The WAN of claim 1, wherein the management programming is accessible via a LAN IP address.

10. The WAN of claim 1, wherein the management programming is accessible via an HTTP web browser protocol.

11. The WAN of claim 1, wherein the management programming is accessible via a dial-in modem.

12. The WAN of claim 1, further comprising a secure access, authentication, and authorization protocol wherein the management programming is configured using at least one of TACACS, RADIUS, or LDAP.
